(19) United States
(12) Patent Application Publication
(10) Pub. No.: US 2012/0293511 A1
(43) Pub. Date: Nov. 22, 2012

(54) METHOD FOR DISPLAYING AN AREA TO BE MEDICALLY EXAMINED AND/OR TREATED

(75) Inventor: Thomas Mertelmeier, Erlangen (DE)

(73) Assignee: Siemens Aktiengesellschaft, Munchen (DE)

(21) Appl. No.: 13/576,867

(22) PCT Filed: Feb. 15, 2011
(86) PCT No.: PCT/EP11/52166

§ 371 Date: Aug. 2, 2012

(30) Foreign Application Priority Data
Feb. 25, 2010 (DE) 10 2010 009 295.9

(51) Int. Cl. G06T 15/00

(52) U.S. Cl. 345/419

(57) ABSTRACT

In a method and device for displaying an area to be medically examined or treated, first and second image data sets are respectively acquired with first and second different imaging modalities, and the first and second image data sets are brought into geometrical registration with each other. The first data set is displayed, and a selected segment is identified therein. Corresponding data in the second image data set are then determined, based on the registration between the two data sets, and the corresponding segment in the second data set is superimposed on the displayed first image data set, overlying the selected segment therein. The second image data set is displayed so as to be rotatable around its image center.

### BACKGROUND OF THE INVENTION

1. Field of the Invention

The present invention concerns a method and a device for displaying an area to be medically examined and/or treated, of the type wherein at least one first image data set of the area to be examined and/or treated, acquired with a first imaging modality, and at least one second image data set of the area to be examined and/or treated, acquired with a second imaging modality different from the first imaging modality, are brought into registration with each other by a processing device.

2. Description of the Prior Art

For the purpose of visualization, in particular of 3D image data of different imaging modalities, such as X-ray tomosynthesis and ultrasound, it is customary that the image data sets acquired by different imaging (image data acquisition) modalities are displayed either on different display screens or on the same display screen, but at different locations, or in different windows. Moreover, data fusion is known, meaning the image data sets acquired using different image acquisition systems, are merged by a suitable computerized processing device to form a collective image data set. Such data fusion enables an image to be displayed of the combined image data sets. The data fusion is extremely computationally intensive, and very difficult with image acquisitions of a deformable object, for which the two individual data sets are generated in different geometries.

### SUMMARY OF THE INVENTION

An object of the invention is to provide a method having an improved shared display possibility of image data sets recorded using different imaging modalities.

According to the invention, the objective is attained by a method of the type specified above, which is distinguished by an image segment being selected in the display of the first image data set on a display, and subsequently the processing device captures the image data set of the image segment of the second image data set corresponding to the selected image segment of the first image data set, and displays the image segment of the second data set at the selected location of the image segment of the first data set as an overlay.

The method according to the invention is implemented according to the following steps. First, image data of the object that is to be examined and/or treated, or the region of an object that is to be examined and/or treated, are acquired using two different imaging s of modalities, and the image data are transferred to the processing device. Two different image data sets, respectively corresponding to the different imaging modalities that are used, are therefore present in the processing device. The two different image data sets are geometrically brought into registration with each other by the processing device, such that a correlation between image points of the first image data set and image points of the second image data set is obtained.

Initially, only the first image data set acquired with the first imaging modality is displayed on a display, i.e. a monitor or similar component. The display of the first image data set preferably occupies the entire display surface of the display, such that a user, for example, can obtain a good overview of the object to be examined and/or treated at a region of this object.

Subsequently, a region, or an image segment of interest, is selected within the displayed first image data set, in which, for example, a distinctive feature is located. The selection can be done manually by at least one user, or automatically by the processing device. In the case of the selection being made by a user, the user selects an image segment from the display of the first image data set. The selected image segment can relate, for example, to a region in which a tumor that is to be monitored, or some other medically distinctive feature, is located. Likewise, the selection may relate to an image segment, for example, that displays an unclear image for the user. The same applies when the selection of the image segment is carried out automatically by the processing device. The selection made by the processing device can be dependent on the clinical history of the object being examined, or can be selected as an image segment by means of algorithms for image recognition of regions that cannot be clearly recognized or categorized, or other structures.

Following this, the image segment of the second data set corresponding to the selected image segment of the first image data set is captured by the processing device. This is possible because the two image data sets are registered together by the processing device when they are entered, meaning that by means of suitable algorithms, they can be mapped onto one another. This is not a data fusion.

The image segment of the second image data set corresponding to the selected image segment of the first image data set captured by the processing device is subsequently simultaneously displayed as an image display at the selected location of the first image data set, replacing the image segment of the first image data set as an image overlay. At this point, it is then possible to see the image acquired with the second imaging modality. A display of the second image data set is located as an excerpt in a section of the display of the first image data set.

It is also understood that numerous, i.e. more than two, image data sets recorded with image recording means of numerous, different modalities may be present. In this manner, the image segment selected in the first image data set can be superimposed selectively with the display of an image data set recorded using image recording means of a second or another modality corresponding to the first data set. A number of different image displays, which can be superimposed on said first image data set corresponding to the number of applied modalities, are therefore available for the selected image segment of the first image data set. Moreover, more than one region may be selected, and replaced in the image by the other image data set.

Preferably, the manual selection is carried out by the user through an operating device, in particular a mouse, a keyboard or a trackball. The user selects at least one image segment from the first image data set by means of a cursor or a similar input indicator, which he or she controls by means of the operating device. Mouses, keyboards, trackballs or graphic tablets are to be considered, not however exclusively, as advantageous operating devices. An operating device is understood to be basically any suitable means with which a user can manually select an image segment within the display of an image data set.

With the automatic selection of the image segment using the processing device, algorithms for recognizing edges or geometric structures, for example, may be implemented in the processing device. The processing device may use thereby, specialized computer aided detection, or diagnosis, systems (CAD systems).

In further development of the invention, it is possible for the image segments of the first and second image data sets to be displayed in the same, or in different dimensions. In this manner it is possible for the image segment of the first image data set to relate to a three-dimensional display, wherein the inserted image section of the second image data set is also a three-dimensional display. Of course, both the first and the second image data sets can also both be presented as two-dimensional displays. Alternatively, the image segment of the first image data set can be a two-dimensional display, wherein correspondingly, the second image segment of the second image data set is a three-dimensional display. Conversely, the image segment of the first image data set would be a three-dimensional display, while the image segment of the second image data set would only be a two-dimensional display.

Advantageously, a three-dimensional display of the second image data set can rotate about its image center. The image center is understood to be the volumetric center point in this context. An improved overview is obtained from the rotation of the three-dimensional display, and if applicable, it is possible in this manner to render hidden structures visible. For this, image processing algorithms can be implemented in the processing device, such as volume rendering (VR), maximum intensity projection (MIP), surface shaded display (SSD). If a three-dimensional tomosynthesis data set is concerned, the rotation is carried out in a limited angular range of the tomosynthesis scanning angle. Generally, the rotation can be carried out automatically or user-driven.

In further embodiment of the invention, the display of the image segment of the second image data set can be deactivated. This enables a quick back and forth, or toggling between the image segment of the first image data set and the image segment of the second data set superimposed on said first data set. The toggling can be carried out, for example, through an operating device, e.g. via a mouse click. In addition, it is possible that in temporal spacings of regular intervals, a toggling occurs between the image segment of the first and the image segment of the second image data set. As a result of the toggling, it is possible in some instances to produce a better visual relationship between the image segment of the first image data set and the image segment of the second image data set.

A tomosynthesis image data set may be used as the first image data set, and an ultrasound image data set may be used as the second image data set. With tomosynthesis processes, which provide X-ray based layer recordings of the object, or region, respectively, to be examined, tissue changes in the framework of a cancer screening, for example, can be better identified, thereby enabling a diagnosis to be more precisely carried out. In particular with breast cancer screening, or identification, respectively, the tomosynthesis has advantages in comparison with conventional mammography processes. Ultrasound image data sets are known from sonography, and enable a spatial (three-dimensional) display of the object, or region thereof, that is to be examined and/or treated.

It is understood that other modalities can also be used, or that the first image data set can be an ultrasound image data set, and the second image data set can be a tomosynthesis image data set.

In addition, the invention relates to a medical examination and/or treatment device, designed for acquiring and displaying images of an area to be medically examined and/or treated, having at least one first imaging (image data acquisition) modality and a second imaging modality differing from the first imaging modality, with at least one image data set of the area to be examined and/or treated, being acquired with the first imaging modality, and at least one second image data set of the area to be examined and/or treated, being acquired with the imaging second modality. A processing device is configured to bring data sets into geometrical registration with each other. The medical examination and/or treatment device is distinguished by the processor being configured to allow or make, in the display of the first image data set on a display, a selection of an image segment therein and thereto capture image data of the image segment of the second image data set, corresponding to the selected image segment of the first image data set, and to be displayed as an image display at the selected location of the image segment of the first image data set, superimposed thereon.

At least two different imaging modalities are embodied in the medical examination and/or treatment device. Image data sets respectively acquired that show or represent an object to be examined and/or treated, with respect to an area thereof with the different imaging modalities, are brought into registration with each other by the processing device. Although the following is based on the use of two different modalities, it is to be understood that more imaging modalities are also conceivable.

A correlation between image points of the first image data set and image points of the second image data set is established through the registration of the image data sets, by means of a transformation regulation. The first image data set is displayed on a display unit, e.g. a monitor or similar component. At least one image segment can be selected from the display of the first image data set, wherein after selecting this image segment, the processing device can capture image data of the second image data set corresponding to the image data of the selected image segment of the first image data set.

The captured image data of the second image data set can then be displayed as an image display at the location of the selected image display of the first image data set, superimposed thereon. Accordingly, only the image segment of the second image data set corresponding to the selection of the image segment of the first image data set is displayed at this location. Thus, an image display of the second image data set is present in the form of an excerpt, within the image display of the first image data set. A fusion of the first image data set with the second image data set is not necessary for this.

The image segment from the first image data set can be selected manually by a user, or automatically by the processing device. A user can use an operating device, in particular a mouse, a keyboard, or a trackball for this, for example, by means of which a cursor or other input indicator that can be controlled on the display means, and thus, an image segment can be selected from the display of the first image data set. The automatic selection is carried out preferably by means of algorithms implemented in the processing device, designed, for example, to recognize, or respectively, to detect edges or other geometric structures. Specialized computer supported programs (computer aided detection/diagnosis programs, i.e. CAD programs) can be implemented in the processing device for this purpose.

Preferably, the image segments of the first and second image data sets can be displayed in the same, or in different dimensions. As a result, it is possible that both image segments can be displayed in two- or three-dimensional formats. Three-dimensional display, in particular of the second image data set, can be obtained, supported for example, by image generating procedures such as volume rendering (VR), maximum intensity projection (MIP) or surface shaded display (SSD). Similarly, the dimensions of the first image set can be different than those of the second image data set. This is the case when one image data set is three-dimensional, and the other is only two-dimensional.

If the second image data set relates to a three-dimensional display, it is preferable for the display thereof to be rotatable about its center. The center is understood in this context to mean the center of the volume that is displayed. In this manner, even more information can be obtained, or respectively, derived, from the corresponding three-dimensional display of the image segment. If the three-dimensional display of the second image data set is based on image data obtained by means of tomosynthesis, then the rotation occurs in the angular range of the tomosynthesis scanning angle. The rotation can be controlled automatically or manually.

Advantageously, the display of the image segment of the second image data set can be toggled. Accordingly, it is possible to toggle back and forth between the image segments of the first and second image data sets, or respectively, toggled from one to the other. The toggling can be initiated by means of a mouse click, or a keyboard command, for example. An automatic toggling, a regular temporal interval for example, is also conceivable.

### BRIEF DESCRIPTION OF THE DRAWINGS

FIG. 1 schematically illustrates a medical examination and/or treatment device according to the invention.

FIG. 2 schematically shows a displayed image of a first image data set acquired with a first imaging modality in accordance with the present invention.

FIG. 3 schematically shows a displayed image of a second image data set acquired with a second imaging modality in accordance with the present invention.

FIG. 4 schematically shows a displayed image of the image data set acquired with the first imaging modality wherein, in accordance with the invention, a segmented portion of the displayed image data set acquired with the second imaging modality is overlaid thereon.

### DESCRIPTION OF THE PREFERRED EMBODIMENTS

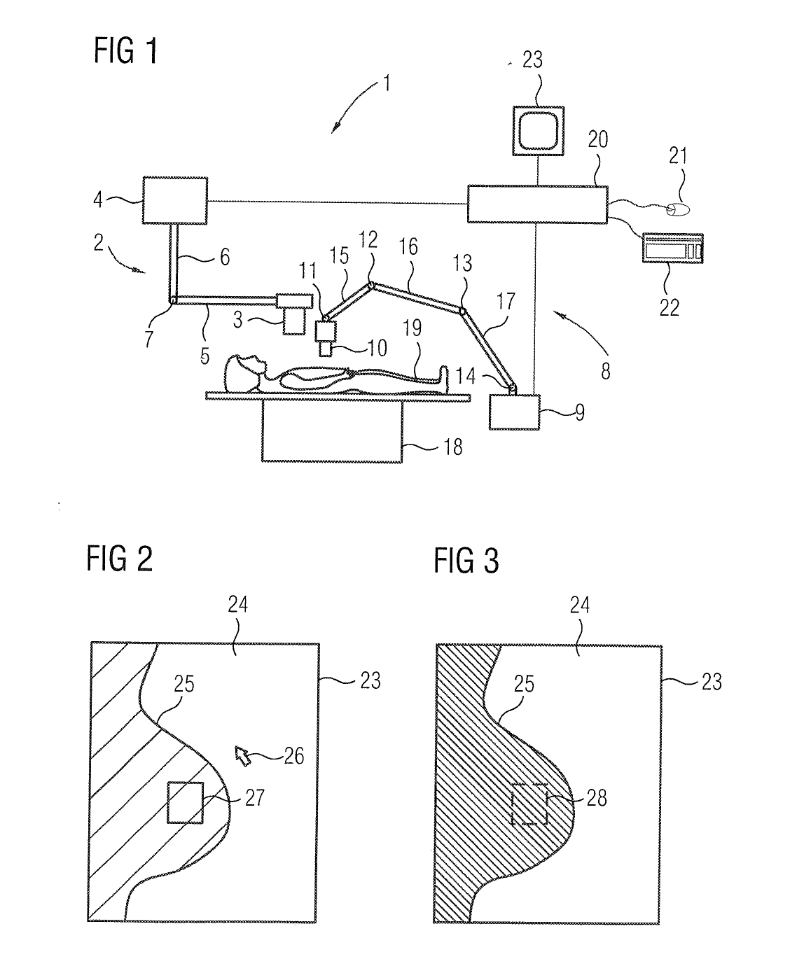

FIG. 1 schematically shows a medical examination and/or treatment device 1 according to the invention. The medical examination and/or treatment device 1 has a first imaging modality in the form of an X-ray device 2, by means of which X-ray images (image data) are acquired and a first image data set is created by a control device 4. For this purpose, the X-ray device has a radiation source 3 and a radiation receiver (not shown). The radiation source 3 is accommodated in an exemplary manner on robot arms 5, 6, connected to one another by a joint 7. As a result, a mobility of the X-ray device that can be controlled by the control device 4 is obtained, corresponding to the degree of mobility of the robot arms 5, 6 and the joint 7.

In addition, the medical examination and/or treatment device 1 has a second imaging modality in the form of an ultrasound device 8, by means of which ultrasound images (image data) are acquired, and a second image data set is created by a control device 9 dedicated to said the ultrasound device 8. The ultrasound device 8 has an ultrasound head 10 for image data acquisition, which can be moved spatially via robot arms 15, 16, 17 connected by means of joints 11, 12, 13, 14, controlled by the control device 9.

A patient 19 is located on a patient bed 18. Tomosynthesis projection images are acquired in the breast region of the patient 19 by means of the X-ray device 2 and a first image data set is created in the control device 4. This is a tomosynthesis image data set is composed of individual, two-dimensional slice images of the imaged area of the patient 19.

Image data of the same area are acquired by the ultrasound device 8, and a corresponding second image data set is created in the control device 9. This is another three-dimensional image data set of the imaged region of the patient 19. The first and second image data sets are made available to the processing device 20 by an appropriate path. The processing device 20 executes a registration of the two image data sets, but not a data fusion thereof. The image points of the first image data set then are in geometric conformity to the image points of the second image data set, meaning that each image point of the first image data set corresponds to an image point of the second image data set. Operating devices in the form of a mouse 21 and a keyboard 22 are connected to the processing device 20. The display of the first image data set is displayed on a monitor 23 (cf. FIG. 2).

FIG. 2 schematically shows an image display of an image data set acquired using image recording means of the first modality, wherein the first modality can be the X-ray device 2 known from FIG. 1. An image display of the breast 25 of the patient is displayed on the display surface 24 of the monitor 23 (hatching from lower left to upper right). This is a tomosynthesis image recording, which means it is a two-dimensional layer recording.

Using the cursor, which can be controlled by a user through a suitable operating device such as the mouse 21 or the keyboard 22, an area of interest to the user, can be selected within the image recording of the female breast 25. This has already been carried out in FIG. 2, indicated by the rectangular marking 27 located within the image display. It is understood hereby that the marking 27 does not need to be rectangular, but instead, may be of any arbitrary shape.

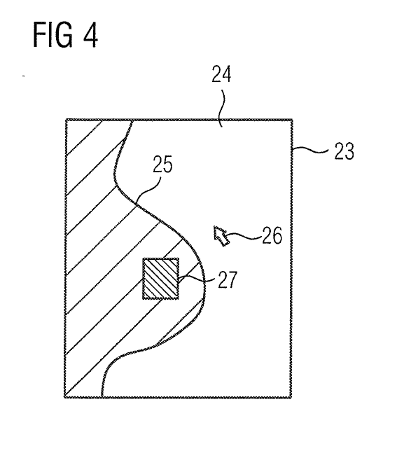

Based on the image segment selected from the display of the first image data set (cf. marking 27) the processing device 20 (cf. FIG. 1) captures the image data of the second image data set (hatching from upper left to lower right) corresponding to the selected image segment of the first image data set. The image segment of the second image data set corresponding to the selected image segment of the first image data set is highlighted in FIG. 3 by the broken-line rectangle 28. In this case, this does not relate to a marking carried out by a user, or by other means.

FIG. 4 schematically shows an image display of the image data set acquired using image data recording means of a first modality, wherein an image display of an image data set recorded using image recording means of a second modality is inserted therein in the form of an excerpt. Thus, in FIG. 4, image data of the second image data set corresponding to the selected location of the image segment of the first image data set (cf. marking 27) are displayed, superimposed on the originally displayed image data of the first image data set, (cf. for this the hatching within the marking 27 characterizing the second data set). Because the second image data set relates to a three-dimensional ultrasound image data set, this supplements the spatial data, because the tomosynthesis, i.e. the first image data set, can only supply limited three-dimensional data. Both modalities supplement each other therefore in the display according to FIG. 4. It is possible with this that the display of the second data set can rotate about the volumetric center, in order thereby to make even more information available with respect to the corresponding image segment. The rotation can be carried out automatically, or be adjusted by a user, through the use of an operating device.

The simultaneous display of the first and said, in part, superimposed second image data set according to FIG. 4 can be activated and deactivated. Accordingly, a toggling can be carried out on the display surface 24 of the monitor 23 between a display according to FIG. 2 and a display according to FIG. 4 by means, for example, of a mouse click or similarly quickly executable operation of a keyboard 22, e.g. by pressing a button.

The display according to FIG. 4 does not relate to a data fusion of the two different modalities of the basic data sets. For an insertion of a segment of the second image data set in the first data set, only a registration of the two different image data sets is necessary. This is computed by the processing device 20, in which the image segment in the second image data set, corresponding to the image segment selected from the image display of the first image data set, is located.

While FIG. 1 shows an examination and/or treatment device, with which the patient is examined, each time while in the horizontal position, using both modalities 2 and 8, such that images are recorded, it is, of course, also possible to undertake the examination or treatment with both modalities while the patient is in different positions, respectively. For example, the data acquisition, i.e. the image acquisition, using a first modality, in this case, the X-ray device 2 is carried out while the patient is standing, with the breast being compressed, during the data acquisition, i.e. the image acquisition using the second modality, in this case the ultrasound device 8, is carried out in the horizontal position, with the breast not being compressed. The respective data sets are fundamentally—independently of the respective recording geometry or, respectively, position of the object—registered with one another.

Although modifications and changes may be suggested by those skilled in the art, it is the intention of the inventor to embody within the patent warranted heron all changes and modifications as reasonably and properly come within the scope of his contribution to the art.

I claim as my invention:

1.-13. (canceled)

14. A method for displaying an area to be medically examined or treated, comprising:
with a first imaging modality, acquiring at least one first image data set of an area to be medically examined or treated;
with a second imaging modality, different from said first imaging modality, acquiring at least one second image data set of said area;
in a processor, bringing said first and second image data sets into geometrical registration with each other;
at a display, visually displaying said first image data set and selecting an image segment in the displayed first image data set;
in said processor, capturing image data in said second image data set that correspond, due to the geometric registration of said first and second image data sets, to said selected image segment of said first image data set;
from said processor, causing the image segment of the second image data set to be superimposed on and overlay said first image data set at said display at a location of the selected image segment of the first image data set; and
from said processor, three-dimensionally displaying said second image data set at said display and allowing rotation of said three-dimensional display of the second image data set around an image center thereof.

15. A method as claimed in claim 14 comprising manually selecting said image segment from said first image data set.

16. A method as claimed in claim 15 comprising manually selecting said image segment by manual operation of an operating device that provides an input to said processor.

17. A method as claimed in claim 14 comprising automatically selecting, in said processor, said image segment of said first image data set.

18. A method as claimed in claim 14 comprising displaying the respective corresponding image segments of said first and second image data sets at said display with identical dimensions.

19. A method as claimed in claim 14 comprising displaying the respective corresponding image segments of said first and second image data sets at said display with different dimensions.

20. A method as claimed in claim 14 comprising selectively deactivating the superimposed display of said image segment of said second image data set on the display of said first image data set.

21. A method as claimed in claim 14 comprising acquiring a tomosynthesis image data set with said first imaging modality as said first image data set, and acquiring an ultrasound image data set with said second imaging modality as said second image data set.

22. A medical examination and/or treatment device comprising:
a first imaging modality configured to acquire at least one first image data set of an area to be medically examined or treated;
a second imaging modality, different from said first imaging modality, configured to acquire at least one second image data set of said area;
a processor configured to bring said first and second image data sets into geometrical registration with each other;
a display in communication with said processor, said processor being configured to visually displaying said first image data set at said display and, via said processor to select an image segment in the displayed first image data set;
said processor being configured to capture image data in said second image data set that correspond, due to the geometric registration of said first and second image data sets, to said selected image segment of said first image data set;
said processor being configured to cause the image segment of the second image data set to be superimposed on and overlay said first image data set at said display at a location of the selected image segment of the first image data set; and
said processor being configured to three-dimensionally display said second image data set at said display and to allow rotation of said three-dimensional display of the second image data set around an image center thereof.

23. A device as claimed in claim 22 comprising manually selecting said image segment from said first image data set.

24. A device as claimed in claim 23 wherein said processor comprises an input unit, and said processor being configured to select said image segment in response to a manual input to said processor made via said input unit.

25. A device as claimed in claim 22 wherein said processor is configured to select said image segment of said first image data set.

26. A device as claimed in claim 22 wherein said processor is configured to cause display of the respective corresponding image segments of said first and second image data sets at said display with identical dimensions.

27. A device as claimed in claim 22 wherein said processor is configured to cause display of the respective corresponding image segments of said first and second image data sets at said display with different dimensions.

28. A device as claimed in claim 22 wherein said processor comprises an input unit, and selectively deactivate the superimposed display of said image segment of said second image data set on the display of said first image data set in response to a manual input to said processor made via said input unit.

29. A device as claimed in claim 22 wherein said first imaging modality is configured to acquire a tomosynthesis image data set as said first image data set, and wherein said second imaging modality configured to acquire an ultrasound image data set as said second image data set.
